(19) United States
(12) Patent Application Publication
(10) Pub. No.: US 2024/0236420 A9
(43) Pub. Date: Jul. 11, 2024

(54) Methods And Systems For Real Time Ad Scene Identification, Skip and Replacement

(71) Applicant: Talent & Acquisition LLC, Seal Beach, CA (US)

(72) Inventors: Quintin Fillmon, Los Alamitos, CA (US); Carlos Herrera, Pasadena, CA (US); Junhua Chang, Seattle, WA (US); Richard Lucas, Phoenix, AZ (US)

(21) Appl. No.: 18/049,270

(22) Filed: Oct. 24, 2022

(51) Int. Cl. H04N 21/454; H04N 21/2668

(52) U.S. Cl. CPC H04N 21/454; H04N 21/2668

(57) ABSTRACT

The present invention discloses improved methods and systems for identifying transitions between programming content and commercial ad content in pre-recorded media files, live digital broadcasts, or streaming media—content streams—that have no ad break markers encoded therein. The process employs iterative, machine learning context models to improve ad break identification accuracy the more it is used. The present invention enables the dynamic replacement of ads already in the content stream with customized ads “on the fly”. The present invention also enables “on the fly” ad skipping in recorded media.

### RELATED APPLICATIONS

None.

### FIELD AND BACKGROUND OF THE INVENTION

The present invention relates generally to the field of video and audio engineering, and in particular, to systems and methods for manipulating pre-recorded and live video and audio content that is broadcasted or streamed with commercial advertisements (“ads”).

Conventional advertisement-supported broadcast television or radio and over-the-top (OTT) programming delivered to viewers, whether live or prerecorded, include commercial ads that are inserted into breaks that occur regularly during the progress of the viewed programs. The ads that are placed into ad breaks of TV/video programming are often 1-5 minutes in length and are often, but not always, preceded with a singular black frame serving as an ad break marker.

Ads are typically created and stored separately from the programs they are added to. Conventionally, at selected times during a broadcast, the ads are spliced into the video feed so as to deliver them to viewers during program breaks. This provides flexibility for changing the ads to be played during a program. Some commercials are inserted at the broadcast origination point by the TV network or other content provider. Other ads may be inserted further downstream by the program service distributor, such as the cable or OTT operator using ad break markers coded into the video as indicators for when the programming breaks and restarts. This is very desirable because the sale and insertion of local and regional advertisements have become a huge source of revenue for the suppliers of ad-sponsored programming to their subscribers/customers.

In this latter model, different ads directed to localized audiences may be inserted into a program that is broadcast over a much wider geographical area. It is thus understood that “targeted ads” can provide great value for advertisers and thus enhanced revenue generating opportunities for the distributors, operators and other providers. Also, during a rebroadcast of a program, ad break markers enable new ads to replace original ads that were burned into the video when the program was originally broadcast. Thus, an important aspect of program delivery is program splicing and, more particularly, ad insertion. Similar arrangements are employed with audio-only streams.

When live broadcasts are recorded, the ads are recorded as well. This creates a scenario with ads that are “burnt-in” with the original video or audio stream content. If ad break markers are not already encoded in the stream during recording, it is time consuming to effectively and reliably identify these ad break starts and ends for future playback in order to differentiate between entertainment and ad content segments. Nonetheless, it is understandably desirable to be able to replace the pre-recorded ads that are burnt in with dynamically generated ads that can be targeted to the viewing audience, thus enhancing the revenue-generating opportunities.

Various solutions for discriminating between programming and ads—“ad detection”—in “content streams” that have not been pre-encoded with commercial ad break markers have been proposed to address this problem. By “content streams” the inventors of the present invention mean any of audio, video or audio/video media files or live audio, video or audio/video media streams that are broadcast or streamed and that comprise programming content, and typically also include advertising content. One conventional, but crude and inefficient, solution is the manual method: a person simply watches (or listens to) the recorded programming on an editing desk and manually adds “ad start” and “ad end” markers to the content stream file. Obviously, this solution is only applicable for recorded shows and is painfully slow and costly. Others have attempted to automate this process by analyzing the video or audio signals of recorded content. One automated solution, for example, attempts to employ the detection of low audio signals as an indicator of a break, transitioning from a program segment end to an ad, or from the end of an ad to the restart of the programming. See for example the solution proposed by U.S. Pat. No. 8,654,255 to Hua, et al. While this single metric “binary” technique (i.e., “Is scene x an ad transition or not?”) may work for some program-to-ad transitions, unfortunately it is subject to high degree of false positives, when, for example, the content itself, whether in the midst of the program segment or the ads, has low audio signals that are similar to the low audio signal threshold set by the system as transition indicators.

What is needed, therefore, is a robust and reliable solution that automatically identifies ad break starts and ends in both pre-recorded and live video and/or audio programming content—media streams—that do not contain ad breaks markers. Such a solution would, in real-time, reliably differentiate between entertainment content and ad content segments, without suffering from the aforementioned problems, thereby enabling automated ad skipping as well as the dynamic (“on the fly”) replacement of “burnt in” ad content in the media streams with custom ad content.

### SUMMARY OF THE INVENTION

The present invention meets these needs and more by disclosing systems and methods for automatically and in real time identifying and marking a commercial advertisement break transition in a content stream that is not pre-encoded with commercial advertisement breaks. In preferred embodiments, the method comprises the steps of receiving in a real-time a learning A/V computing engine the content stream; parsing the content stream into content stream scenes; selecting a current scene from the content stream scenes for identifying whether the scene is likely programming content or advertising content; using a scene recognition subsystem of the computing engine, conducting at least one of object and speech recognition analyses on the current scene to recognize one or more objects and/or speech streams in the scene; automatically selecting a first visual or audio context model corresponding to a first recognized object or speech stream for operation on the content stream scene, the context model selected from a set of context models stored in the computing engine (108); applying the selected context model on the scene to extract information from the scene indicative of whether the scene is likely programming content or advertising content (109); computing a preliminary score on the extracted information to quantify a likelihood of the scene being programming content or advertising content (110); and comparing the computed context model preliminary score for the current scene against preexisting and stored scene scores computed using the selected context model for prior scenes in the content stream, if any (112).

In further embodiments, the method further includes using the recognized objects and/or speech streams in the scene, automatically selecting one or more additional audio or visual context models, if any, each corresponding to an additionally recognized object or speech stream for operation on the content stream scene (108); and repeating the last three steps for each additionally recognized object or speech stream having a corresponding context model. Finally, the method aggregates the preliminary scores computed on all extracted information for the scene into an aggregated computed similarity score. Further, when the aggregated computed similarity score of the current scene is less than an aggregated acceptance threshold (that may be provided by the system or calculated by the machine learning algorithm, or predetermined or determined another way that may be understood by one skilled in the art), the method of the present invention classifies the current scene as a transition between programming content and advertising content. Then, the method may electronically mark the scene transition with an ad break marker.

In embodiments, when the computed similarity score of the current scene is greater than the acceptance threshold, the scene is classified as programming content.

In more detailed embodiments, the step of conducting at least one of object and speech recognition analyses on the current scene to recognize one or more objects and/or speech streams in the scene further includes the step of inputting into the scene recognition subsystem known object and speech patterns stored in a scene classification database.

In various embodiments, a set of context models is provided for use by the method of the present invention. These models may include one of more of an actor identification model, a scene object identification model, topics-of-discussion model, an audio level model, and a blackscreen model. Other context model are contemplated by the present invention.

In other embodiments, the content stream is live broadcast television programming. In others, it may be a recorded video or audio or A/V file. In preferred embodiments, the present invention is capable of adding ad break markers to the content stream in real time.

It is to be understood that the invention is not limited in its application to the details of construction and the arrangement of components described hereinafter and illustrated in the drawings and photographs. Those skilled in the art will recognize that various modifications can be made without departing from the scope of the invention.

### BRIEF DESCRIPTION OF THE FIGURES

Further advantages of the present invention may become apparent to those skilled in the art with the benefit of the following detailed description of the preferred embodiments and upon reference to the accompanying drawings in which:

FIG. 1 is a block process flow diagram showing steps implemented in accordance with one non-limiting preferred embodiment of the commercial ad recognition and replacement system of the present invention;

FIGS. 2a-2e are process flow diagrams showing various video and speech context models that may be employed by the present invention in accordance with one non-limiting preferred embodiment;

FIG. 3 is a flow diagram showing the determination of ad content from aggregation and ensemble prediction from various context models according to one preferred method according to the present invention;

FIG. 4 is a block diagram showing components of the scene recognition subsystem according to one embodiment; and

FIG. 5 is a high level block diagram showing basic system components of the present invention.

### DETAILED DESCRIPTION OF THE INVENTION

Referring now to the drawings, like reference numerals designate identical or corresponding features throughout the several views.

The present invention takes a novel approach to ad scene identification in both live and pre-recorded video that does not include ad markers by applying in real time a novel combination of machine learning algorithms to a video stream containing both programming content and non-program content, such as commercial ads. In particular, the systems and methods of the present invention use real-time machine learning to automate recognition of objects and speech to differentiate entertainment content with burnt-in commercial ad content segments.

The present invention accomplishes this advance in systems and methods for scene detection by preferably ingesting pre-recorded or live video content, and comparing multiple audio, visual, and contextual cues in a current scene against previously played scenes to determine on the fly if the video stream is no longer streaming entertainment content and has switched to an ad break. If a scene in the video content is recognized as a commercial ad, a “begin-ad” timestamp is recorded and a “begin-ad” ad marker is inserted into the video content to signify the start of a commercial ad break. When the machine learning algorithm recognizes that the ad break is over and entertainment programming content is resuming, an “end-ad” timestamp is recorded, and a marker is inserted into the video stream to signify the end of the commercial ad break. The video stream with ad markers added signifying the start and end of the commercial break can then be ingested by a dynamic ad insertion (DAI) system which can automatically replace the existing burnt-in commercial ads with targeted commercial ads in real-time.

The present invention is extremely beneficial to Multichannel Video Programming Distributors (MVPDs) who offer digital video recording (DVR) services allowing customers to record live content such as series/episodic content, movies, and sports events that contain commercial breaks. This creates an opportunity to monetize revenue using generating dynamic ad insertion by replacing burnt-in ads with targeted advertising.

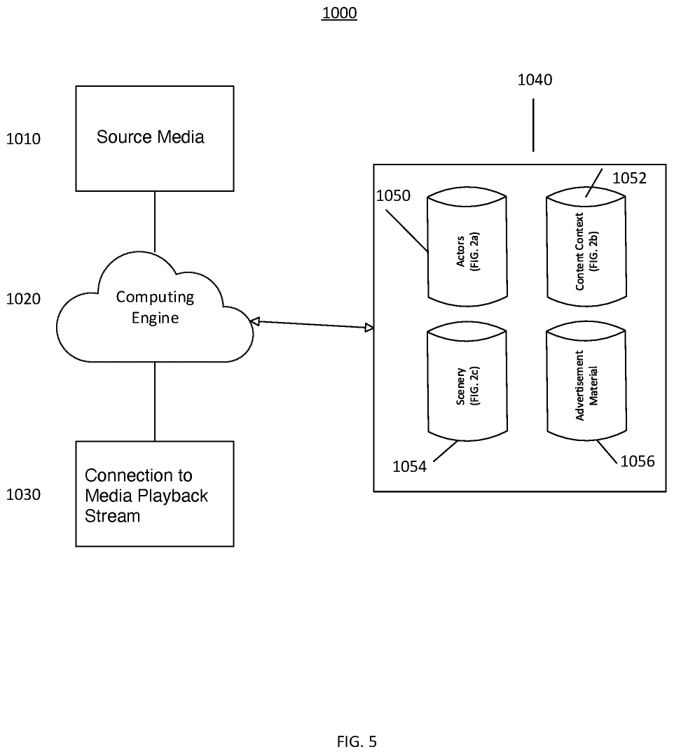

One high level block diagram embodiment of the system 1000 of the present invention according to one embodiment is shown in FIG. 5. In particular, the system comprises a real time, learning A/V computing engine 1020 and a set 1040 of databases 1050, 1052, 1054 and 1056 that write to and are written from computing engine 1020. In this basic architecture, source media 1010, whether for example, a live broadcast stream, a recorded video stream, or an audio stream, inputs its contents to computing engine 1020 to, as detailed below, perform on-the-fly analyses of the content to automatically discriminate between programming content and commercial ads and to place ad markers at programming-commercial transitions. Computing engine 1020 in turn connects with a media playback stream content provider to enable that provider to automatically replace the ad content in the original feed with customized ads, all on the fly.

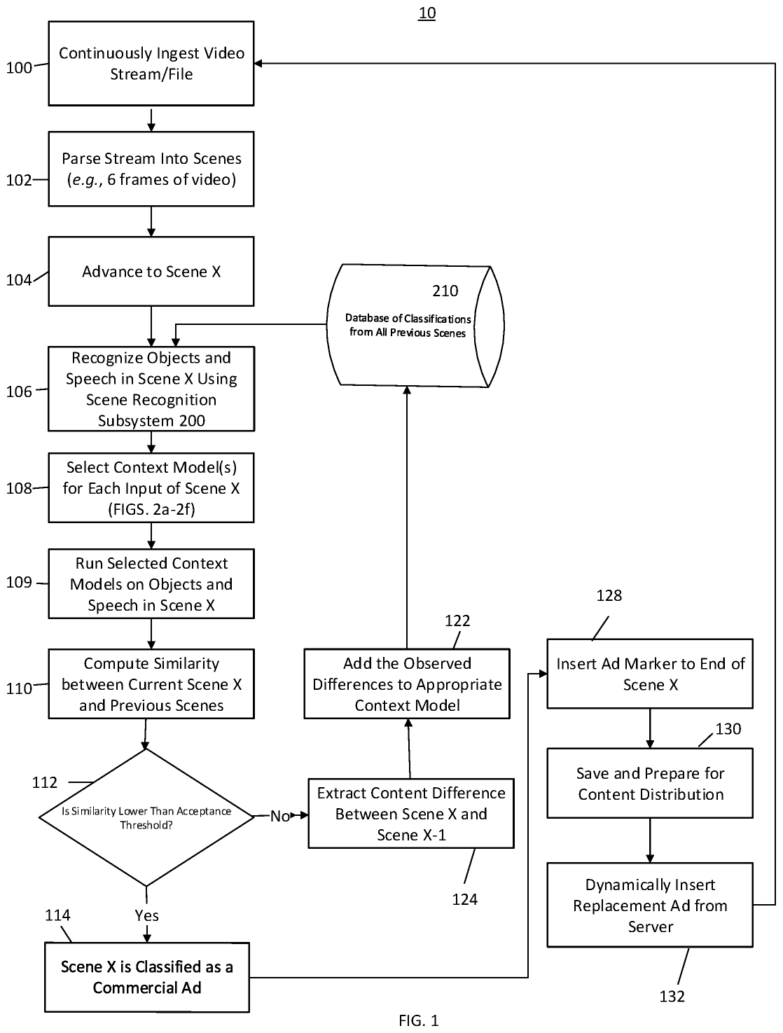

One embodiment of the ad content recognition and replacement invention disclosed herein is shown in the block diagram of FIG. 1. This flow diagram shows a high-level process flow 10 implemented by system for automatically recognizing and classifying commercial ads in streamed content that may or may not contain ad markers. As will be shown, this is an iterative and self-learning process that gets better at predicting ad breaks with use and time.

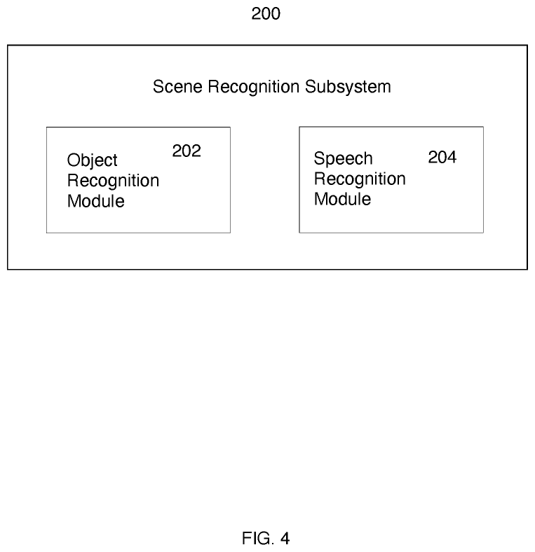

At step 100, the system of the present invention ingests a content stream from either a live video stream or video file. The ingested video content could be a currently broadcasted live show or may be recorded content (an A/V file, like a recorded TV show) actively distributed to end users. At step 102, the system parses the ingested video content into scenes using an image scene cutter 12. For example, in one preferred embodiment, a scene may comprise 6-frames of video captured for video shot at a standard 24 frames per second (fps) rate. However, it is understood that a scene may comprise any other short piece or snippet of A/V content. Next, in step 104, a scene X is selected and advanced to scene recognition step 106. Here, the software of the system attempts to recognize all identifiable objects and the speech in scene X. Turning momentarily to FIG. 4, this recognition step is executed with scene recognition subsystem 200, comprising objection recognition module 202 and speech recognition module 204. Here, using conventional object recognition technology, module 202 attempts to recognize and record the types of visual objects found in scene X, such as whether an object is an actor, another a car, or other identifiable objects, or whether the scene is or contains mere background scenery. Speech recognition module 204 attempts to recognize and record speech characteristics, such as the nature of the conversation, the voices, etc.

As seen, another input to step 106 (scene recognition subsystem 20) is classification database 210, which stores object and speech classifications from previous scenes and compares those classifications with the current content. Thus, if a previous scene stored in classification database 210 associated an image in the scene as an infant, than a similarly shaped object in the scene might also be characterized as an infant.

Next, in the preferred embodiment, system 10 employs machine learning to accomplish ad content recognition. To do this, object recognition and speech recognition are conducted on visual and audio content from each scene. The results of this analysis are then used to determine if a scene contains entertainment content or ad content. These learning “models” extract information available describing the context of the content being presented in the video and audio streams. Extracted information may include, but is not limited to, background scene setting”, “actor complement” (i.e., the number and identity of actors in a given scene), context of the discussion, volume of the audio file, black screen identification, cues or other markers indicating ad placement, standard times for ad breaks, or other information as available.

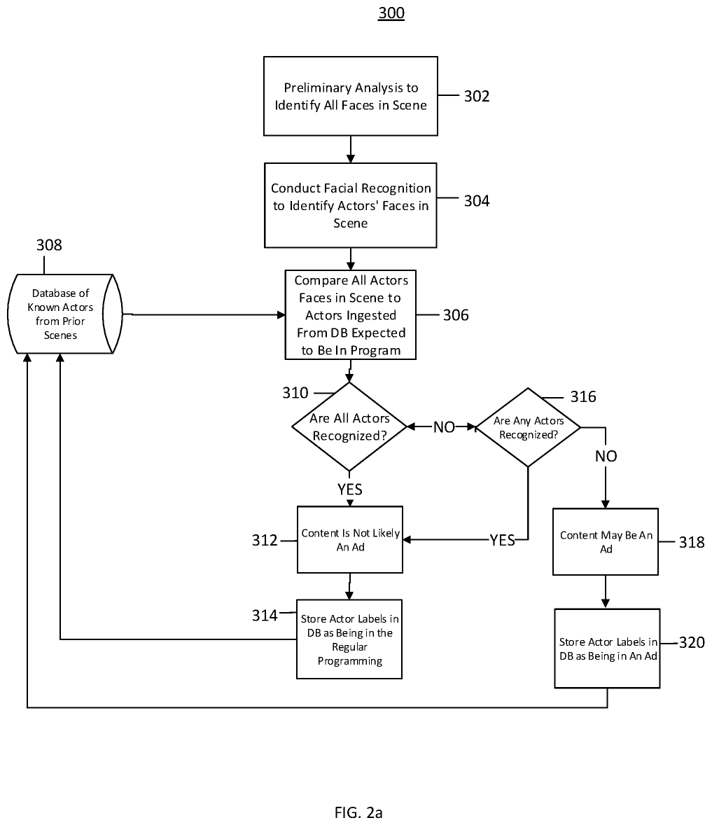

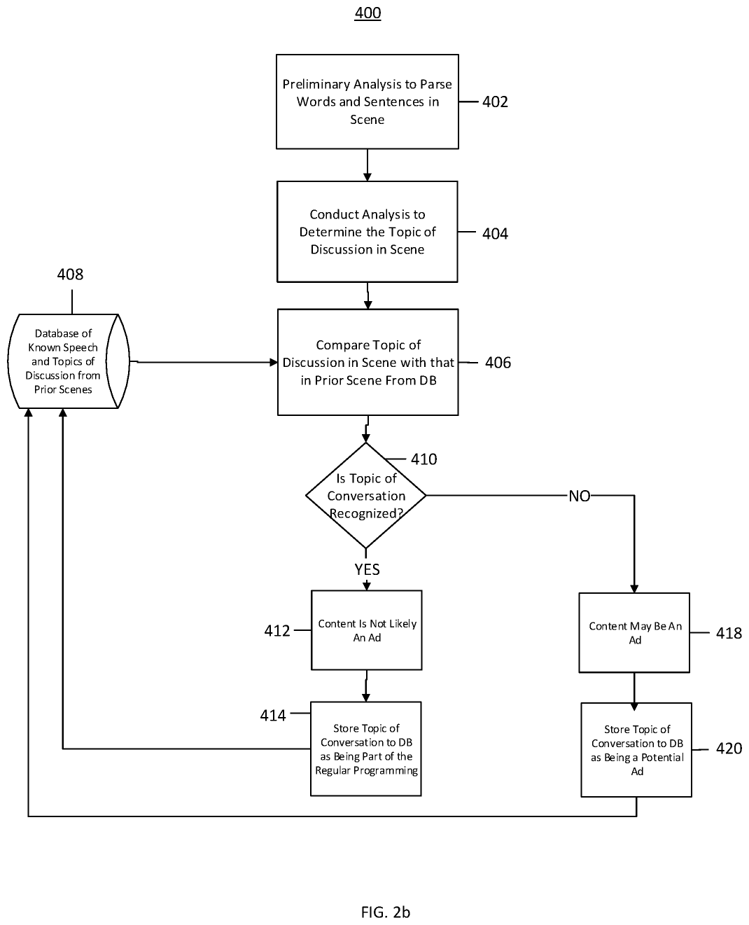

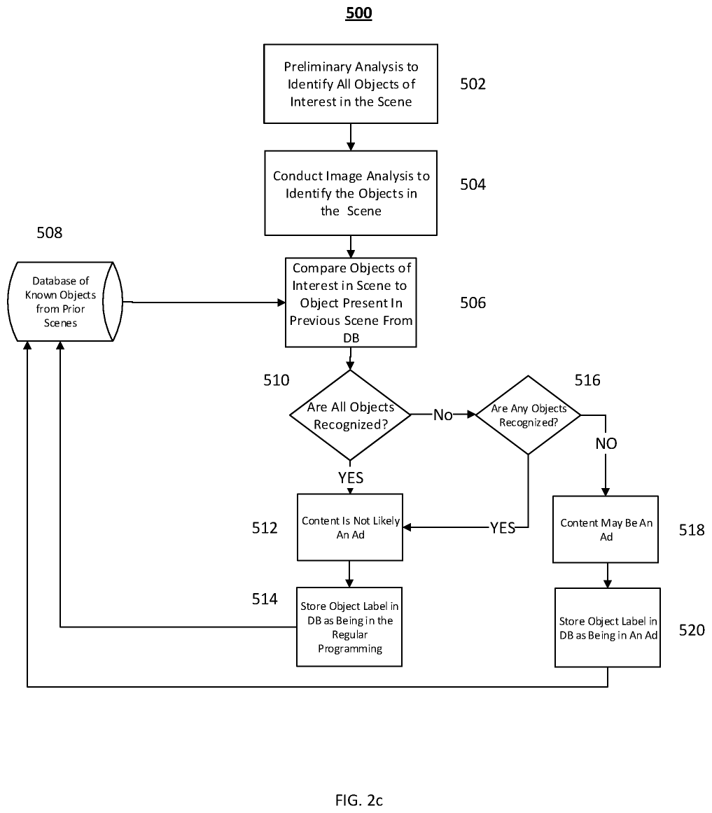

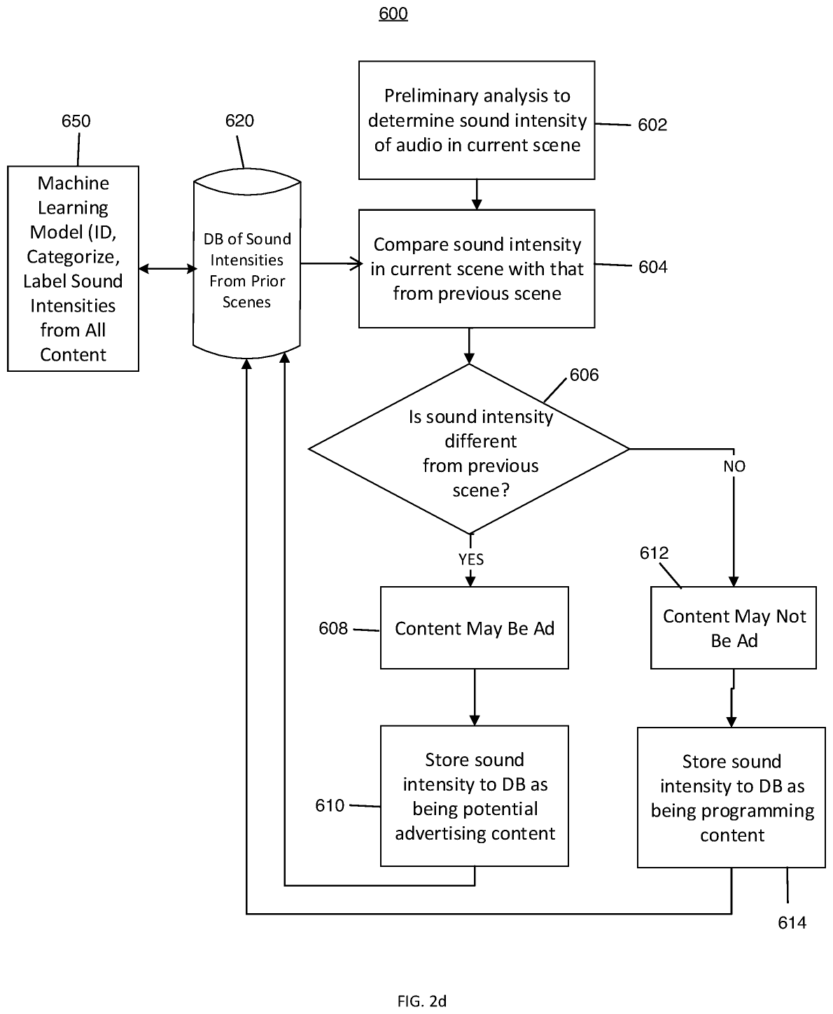

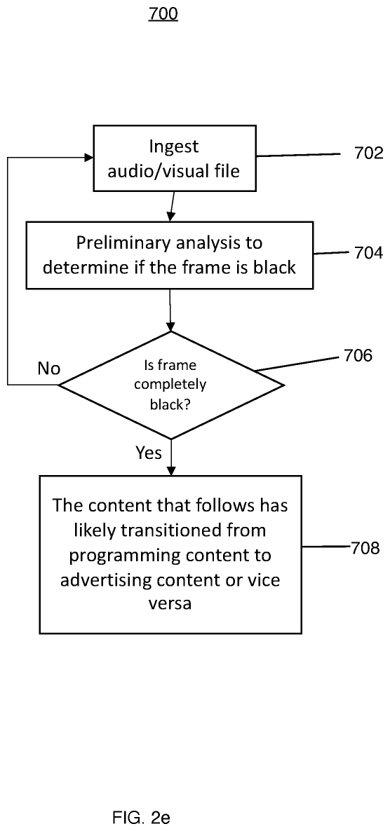

Accordingly, for any scene X being analyzed, in step 108, one or more “context models” are identified and selected as relevant for that scene using the recognized objects and speech from step 106. Various exemplary machine learning context models 300, 400, 500, 600, 700 are detailed in FIGS. 2a through 2e, respectively. FIGS. 2a, 2c and 2e are block diagrams showing exemplary visual context models, namely, “actor complement” 300, “background scene recognition” 400 and black screen recognition 700, respectively. FIGS. 2b and 2d are block diagrams detailing two speech recognition context models, namely, topic of discussion model 500 and audio volume model 600, respectively. Thus, for example, if one or more faces or bodies of a human are identified in scene recognition step 106, then in step 108, the system would select, and in step 109 activate (“run”) actor complement model 300 to attempt to identify whether that actor is identifiable and who he or she is in programming or the advertisement.

Details of each of these preferred context models employed in connection with the presently described embodiment are now explained. Considering first the visual context models, the visual content within a video stream is extracted and compiled using object recognition on both actors and scenery contained within the scene. In actor complement model 300 shown in FIG. 2A, in step 302 a preliminary analysis is conducted to identify all faces (that is, the number of faces) in scene X. Next, in step 304 the software runs a facial recognition on each face to identify who the actors are in the programming. In addition, in step 306, the system tries to match the actors' faces in the scene with a database 308 of the actors' faces known to be in the program from prior scenes. Actor database 308 may be previously compiled, or it may be instantiated, populated, and compiled using data solely from the context of the current video file during run time. The facial recognition module used for step 304 may be previously trained, or it may train during runtime of the video content.

Now, at decision 310, actor complement model 300 asks whether all actors in the scene are recognized from previously played scenes. If the answer to that question is “YES”, then the system decides at step 312 that the content is likely programming (the show) and not likely an advertisement. However, if the answer to question 310 is that not all actors are likely recognized, then the system further asks at step 316 whether any program actors are recognized. If “NO”, then at step 318, model 300 concludes that the content in scene X may be an ad and not the program, and at step 320 labels faces identified therein as Ad Actors and sends that tentative conclusion to actor database 308. However, if the answer to question 316 is “YES”—that some but not all faces in the scene are recognized as show actors—the algorithm is programmed to conclude that the content is not likely an Ad at step 312.

However, the content in scene X is determined from the actor complement to likely not be an ad in step 312, step 314 then labels faces identified therein as Ad Actors and sends that data to be stored actor database 308 for use against future analyzed scenes.

Turning to the next visual model, FIG. 2c discloses context model 500 activated when visual objects other than faces in a scene are detected by scene recognition subsystem 20 in Step 106 of FIG. 1. In a first step 502, the model does a preliminarily analysis of the scene to simply identify all objects of interest that are not faces (potential actors). Then, in step 504, the engine conducts image analysis to fully identify the objects of interest in the scene. In step 506, the system then compares the objects of interest in the scene against objects present in previous scenes which are pulled from Database of Known Objects 508. If at decision 510 all objects are recognized as objects found in programming, then context model 500 at step 512 determines that the content is not likely an advertisement. In that case, at step 514, the objects are label as being in regular programming and not as an ad, and these object labels are in turn stored in Database of Known Objects 508 as programming objects.

On the other hand, if at decision 510 not all objects are recognized as programming objects, then model 500 further asks at step 516 if any objects are recognized as an object that is found in a program (not commercial ad) scene. If the answer is YES, then the algorithm loops back to step 512 with the conclusion that the content is not likely an ad, and labels and catalogs those objects as programming ads for storage in DB 508. Only if at step 516 no objects are recognized as programming objects does the model at step 518 conclude that the scene may be an advertisement. In that case, at step 520, the objects are labels as advertisement objects and stored in DB 508 as such.

The final visual algorithm that may be invoked for A/V content scene in this preferred embodiment is the Blackscreen Recognition model. One simple preferred embodiment is model 700 as shown in FIG. 2e. As seen, at step 702, the video file is ingested and at step 704 the model does a preliminary look to determine whether the frame in the scene is completely black. If at decision point 706 the frame is determined to be completely black, then the model at step 708 decides that the content that follows is likely a transition from programming content to ad content or vice versa. On the other hand, if the frame is determined at step 706 to not be completely black, then the system considers the content to follow to not likely be a transition and the model simply ingests the next frame (or file).

Turning now to speech recognition models in the presently preferred embodiment, Speech recognition model 400 is shown in FIG. 2b. In step 402, a preliminary analysis is preferably conducted on the audio in the selected scene in order to parse out the words and sentences in the scene. Once done, in step 404, an analysis is conducted on the words and sentence to try to determine the topic of discussion in the scene. Next, the topic determined in step 404 is compared in step 406 to the topic determined to be in the prior scene which is stored in Database of Known Speech Topics 408. If at decision step 410 the topic discerned in step 404 is recognized to be the same or similar to the topic in the prior scene which was programming content, then at step 412 the content of this scene is determined to not likely be an ad, and at step 414 the topic of conversation in this scene is labeled and stored to the DB 408 as being part of the regular programming. If, on the other hand, the topic of conversation at decision 410 is not recognized as programming content, then as indicated at step 418 the scene content is deemed as a possible ad, and therefore the topic of conversation is designated as such at step 420 and stored to database 408 as such for use in a subsequent scene analysis in this model 400.

The final sound recognition model employed by the presently preferred embodiment is the audio level model, one of which is model 600 shown in FIG. 2d. The idea here is that decibel level or volume change (whether louder or softer) can distinguish between programming content and advertising content. In particular, after model 600 ingest an A/V scene, in step 602, the model runs a preliminary analysis on the tile to determine a sound intensity of the audio in the current scene. Then, at step 604, the algorithm compares the sound intensity of this current scene (e.g., in decibels) to the sound intensity that was recorded in the previous scene and which was previously stored in Database of Sound Intensities, DB 620. At decision step 606, the model asks whether the intensity is different from the prior scene. If the answer is “Yes”, then at step 608, the model decides that this scene may be an advertisement (or, more generally, a transition from program to ad or ad to program). If that's the case, in step 610, the system stores to DB 620 this sound intensity as a potential ad content. However, if the system at decision step 606 does not detect a different sound intensity, then at step 612, the system determines that the content may not be an ad (or transition). In this case, at step 614, this sound intensity is stored to DB 620 as likely being programming content. The large of amount of sound intensity is stored in the database using machine learning model 650 that serves to identify, categorize and label all this data from all scenes captured.

It should be understood that all of these and other context models work individually in an iterative fashion in that their content databases get “smarter” with greater use—that is, with machine learning—and therefore the accuracy of these “learning modules” get better with time as the databases grow with relevant data from previous learnings.

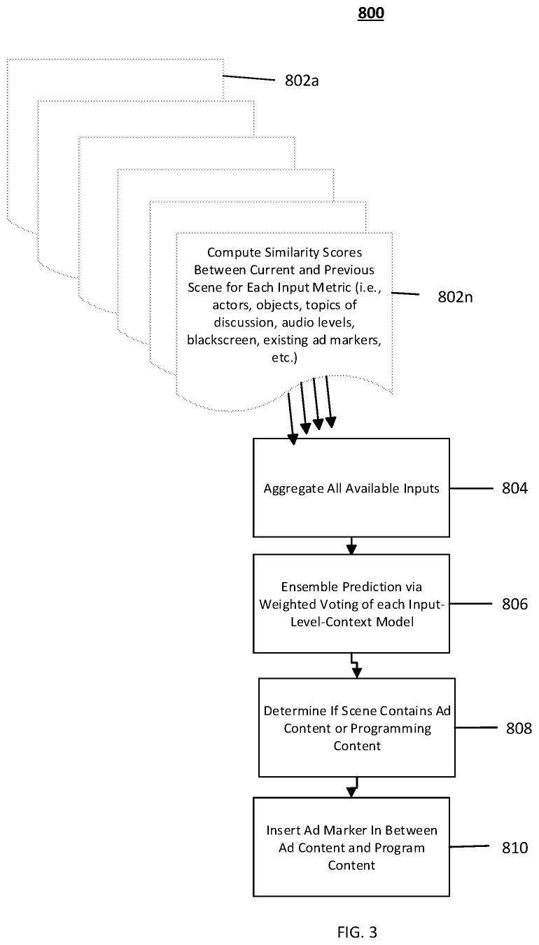

Turning now to back to FIG. 1, now that all selected content models for a given scene X were run in step 109, step 110 takes the outputs from all models run to compute an overall similarity value between scene X and the ones before it. In one preferred embodiment, step 110 is explained is greater detail in connection with FIG. 3. As seen, for a current scene X, context model similarity scores 802a-802n are computed for each metric. The similarity score is between the current scene and previous scene for each metric, such as the actor recognition, topics of discussion, audio levels, blackscreen, and existing ad markers, to name some. At step 804 all metrics scores are aggregated together. Moreover, optionally, in step 806 each metric may be weighted relative to the other to assign a relative importance to each metric such that when aggregating all to get an overall similarity score for step 110, the calculation involves “weighted voting” as will be understood by those with skill in the art to result in an “ensemble prediction” for determining in step 808 whether the scene contains programming or ad content.

Back again to FIG. 1, if at decision 112 the aggregated and weighted similarity score from step 110 is lower than an acceptance threshold similarity value (to a value representing programming content), then at step 114 Scene X is classified as a commercial ad scene.

Optionally, then, the system of the present invention at step 128 on the fly inserts an ad marker to the end of Scene X indicating it is an advertisement. Now the scene can be saved and prepared for content distribution at step 130. This can now serve as a marker for dynamically and in real time inserting at step 132 any replacement ad from an ad server to the scene string that represents the predicted ad content. At this point, the ad identification and replacement for that scene/snippet is complete and the system ingests the next scene/snippet of A/V content to repeat the process on it. Now, the databases, however, are loaded with an additional set of data from scene X.

However, if at decision 112 the similarity score of scene X (to a value representing prior stored programming content) is not lower than the acceptance threshold, meaning the scene is similar enough to the prior scenes it was compared to, then at step 124 the system extracts content difference between Scene X and the scene before it Scene X−1, and at step 122 adds the observed differences to the appropriate context model and to the classification database 210. In a feedback loop, this ever-growing database provide input back into object and speech recognition module 106.

While embodiments of the invention have been illustrated and described, it is not intended that these embodiments illustrate and describe all possible forms of the invention. Various changes, modifications, and alterations in the teachings of the present invention may be contemplated by those skilled in the art without departing from the intended spirit and scope thereof. It is intended that the present invention encompass such changes and modifications.

1. A method for automatically and in real time identifying and marking a commercial advertisement break transition in a content stream that is not pre-encoded with commercial advertisement breaks, the method comprising:
a. receiving in a real-time learning A/V computing engine the content stream;
b. parsing the content stream into content stream scenes;
c. selecting a current scene from the content stream scenes for identifying whether the scene is likely programming content or advertising content;
d. using a scene recognition subsystem of the computing engine, conducting at least one of object and speech recognition analyses on the current scene to recognize one or more objects and/or speech streams in the scene;
e. automatically selecting a first visual or audio context model corresponding to a first recognized object or speech stream for operation on the content stream scene, the context model selected from a set of context models stored in the computing engine (108);
f. applying the selected context model on the scene to extract information from the scene indicative of whether the scene is likely programming content or advertising content (109);
g. computing a preliminary score on the extracted information to quantify a likelihood of the scene being programming content or advertising content (110); and
h. comparing the computed context model preliminary score for the current scene against preexisting and stored scene scores computed using the selected context model for prior scenes in the content stream, if any (112).

2. The method of claim 1, further including:
using the recognized objects and/or speech streams in the scene, automatically selecting one or more additional audio or visual context models, if any, each corresponding to an additionally recognized object or speech stream for operation on the content stream scene (108);
repeating steps f.-h. for each additionally recognized object or speech stream having a corresponding context model; and
aggregating the preliminary scores computed on all extracted information for the scene into an aggregated computed similarity score.

3. The method of claim 2, wherein when the aggregated computed similarity score of the current scene is less than an acceptance threshold, classifying the current scene as a transition between programming content and advertising content; and electronically marking the scene transition with an ad break marker.

4. The method of claim 3, wherein when the computed similarity score of the current scene is greater than the acceptance threshold the scene is classified as programming content.

5. The method of claim 1, wherein step d further includes the step of inputting into the scene recognition subsystem known object and speech patterns stored in a scene classification database.

6. The method of claim 1, wherein the set of context models comprises one or more of an actor identification model, and a scene object identification model.

7. The method of claim 1, wherein the set of context models comprises one or more of a topics-of-discussion model, an audio level model, and a blackscreen model.

8. The method of claim 1, wherein the content stream is live broadcast television.

9. The method of claim 4, wherein the content stream is live broadcast television and is classified as programming or advertising content in real time.

10. The method of claim 6, wherein the actor identification context model comprises the steps of conducting facial recognition on the scene; comparing all faces identified in the scene to a database of faces of known actors from prior scenes classified as programming content; and determining from the comparison whether the scene is likely programming or advertising content.

11. The method of claim 6, wherein the scene identification context model comprises the steps of conducting image analysis on the scene to identify objects in the scene; comparing objects in the scene to a database of known objects from prior scenes classified as programming content; and determining from the comparison whether the scene is likely programming or advertising content.

12. The method of claim 7, wherein the topics-of-discussion model comprises the steps of conducting a preliminary analysis on the audio in the scene to parse any words and sentences spoken in the scene; conducting a secondary analysis on the parsed words and sentences to determine a topic of discussion in the scene; comparing the topic of discussion in the scene to a database of known speech and topics of discussion from prior scenes classified as programming content; and determining from the comparison whether the scene is likely programming or advertising content.

13. The method of claim 7, wherein the audio level context model comprises the steps of:
a. comparing the audio level of the current scene to the audio level of the scene immediately preceding the current scene; and
b. if the difference between the audio level of the current scene and the audio level of the preceding scene is larger than a threshold automatically determined by a machine learning audio module, determining that the current scene may likely be a transition between programming and advertising content.

14. The method of claim 13, wherein the machine learning audio module determines the threshold using a database of known audio levels from prior scenes.

15. The method of claim 7, wherein the blackscreen context model comprises the steps of:
a. analyzing the current scene for the presence of a blackscreen frame within the current scene; and
b. upon observation of a blackscreen, determining that the current scene may be a transition from programming to advertising content or from advertising content to programming content.

16. The method of claim 1, wherein commercial advertising content is used to replace advertisements that were burned into the content stream.

17. The method of claim 1, wherein identifying and marking of a commercial advertisement enables “on the fly” skip ad functionality.

18. A real-time, learning A/V computing engine for discerning a commercial advertisement break transition in a content stream that is not pre-encoded with commercial advertisement breaks, the method comprising:
a. a scene selector for parsing the content stream into content stream scenes;
b. a scene recognition subsystem for conducting at least one of object and speech recognition analyses on the current scene to recognize one or more objects and/or speech streams in the scene;
c. a set of context models stored in the computing engine each adapted to recognize objects or speech streams for operation on content stream scene;
d. a context model selector for selecting a context model from the set to apply to the scene; and
e. a database for storing outputs of analyses of selected scenes.

19. The real-time, learning A/V computing engine of claim 17, further including an scene aggregation subsystem that aggregates the outputs from the operation of selected context models to determine whether the scene is a commercial advertisement break transition scene.

20. The real-time, learning A/V computing engine of claim 18 further including a scene marker to automatically mark a scene of the content stream when it is determined to be a commercial advertisement break transition.

21. A method for automatically identifying and marking a commercial advertisement break transition in a content stream, the method comprising:
a. receiving in a real-time learning A/V computing engine the content stream;
b. parsing the content stream into content stream scenes;
c. selecting a current scene from the content stream scenes for identifying whether the scene is likely programming content or advertising content;
d. using a scene recognition subsystem of the computing engine, conducting at least one of object and speech recognition analyses on the current scene to recognize one or more objects and/or speech streams in the scene;
e. automatically selecting a first visual or audio context model corresponding to a first recognized object or speech stream for operation on the content stream scene, the context model selected from a set of context models stored in the computing engine;
f. applying the selected context model on the scene to extract information from the scene indicative of whether the scene is likely programming content or advertising content;
g. computing a preliminary score on the extracted information to quantify a likelihood of the scene being programming content or advertising content; and
h. comparing the computed context model preliminary score for the current scene against preexisting and stored scene scores computed using the selected context model for prior scenes in the content stream, if any;
i. using the recognized objects and/or speech streams in the scene, automatically selecting one or more additional audio or visual context models, if any, each corresponding to an additionally recognized object or speech stream for operation on the content stream scene;
j. repeating steps f.-h. for each additionally recognized object or speech stream having a corresponding context model; and
k. aggregating the preliminary scores computed on all extracted information for the scene into an aggregated computed similarity score;
wherein when the aggregated computed similarity score of the current scene is less than an aggregated acceptance threshold, classifying the current scene as a transition between programming content and advertising content, and electronically marking the scene transition with an ad break marker.
